(19) United States
(12) Patent Application Publication
(10) Pub. No.: US 2009/0070332 A1
(43) Pub. Date: Mar. 12, 2009

(54) INFORMATION RETRIEVAL

(76) Inventor: Stuart Beet, West Ella (GB)

Correspondence Address: SMITH-HILL AND BEDELL, P.C., 16100 NW CORNELL ROAD, SUITE 220, BEAVERTON, OR, 97006, US

(21) Appl. No.: 11/853,226

(22) Filed: Sep. 11, 2007

(51) Int. Cl. G06F 17/30

(52) U.S. Cl. 707/9; 707/E17.008

(57) ABSTRACT

A method of dynamic information retrieval from a plurality of data sources, each data source being a potential repository of necessary data, determining a stored access profile defined by a combination of specific data sources and/or data types on a particular data source, allocating a stored data access profile to a user, the user retrieving a data collection to form the necessary data in accordance with the stored access profile with the data collection taken from the specific data sources and/or data types, the user and/or a controller monitoring proportional usage of the necessary data to dynamically adapt the stored access profile in terms of the combination define by the specific data sources and/or data types on a particular data source for subsequent retrieval of the necessary data by the user, the adaption dependent upon dynamically maintaining at least a predefined quotient for the usage of the necessary data and/or parts of the necessary data.

The present invention relates to information retrieval and dynamic management and more particularly information retrieval from disbursed information sources.

Increasingly organizations such as companies and public utilities have separate information systems and retrieval networks comprising a number of data sources. Each of these systems and data sources will typically be operated and tailored to particular requirements. Thus, financial and other functions within a company may have a system and process optimized with regard to accounting and processing of numbers whilst other departments such as production or research and development will have alternate data sources to optimism retrieval information in their particular sphere of activity. Information retrieval is further complicated by individual users within an organization having different requirements and levels of access to data and data types as well as data sources within the organization. Furthermore, as circumstances change then so does the requirement for data and information needed by different roles and functions. In such circumstances in terms of information retrieval obstacles and difficulties are presented by diverse information sources and requirements that change over time.

In view of the complexities typically an individual with a level of access or role within an organization will have different access codes for each data source and will generally retrieve information from each individual data source as required and collate manually themselves or specifically copy data to a particular repository for themselves. Such approaches result in immense numbers of connections and combinations inhibiting convenient data retrieval. Furthermore, an individual user may not be aware at the outset of the most convenient connects or data sources for their tasks. Centrally, management functions performed by different people will also have difficulty gaining and maintaining a view overall of the process and requirements as they change over time. Furthermore, as results are generated for roles these in themselves might reveal new requirements for management and distribution. Information requirement logistics are therefore highly complex.

In accordance with aspects of the present invention there is provided a method of information retrieval from a plurality of data sources, each data source being a potential repository of necessary data, determining a stored access profile defined by a combination of specific data sources and/or data types on a particular data source, allocating a stored data access profile to a user, the user retrieving a data collection to form the necessary data in accordance with the stored access profile with the data collection taken from the specific data sources and/or data types, the user and/or a controller monitoring proportional usage of the necessary data to adapt the stored access profile in terms of the combination defined by the specific data sources and/or data types on a particular data source for subsequent retrieval of the necessary data by the user, the adaption dependent upon maintaining at least a predefined quotient for the usage of the necessary data and/or parts of the necessary data.

Other aspects of the present invention will be defined in the description and claims below.

Aspects of the present invention will be described with regard to embodiments of the invention as defined in the enclosed drawings in which:

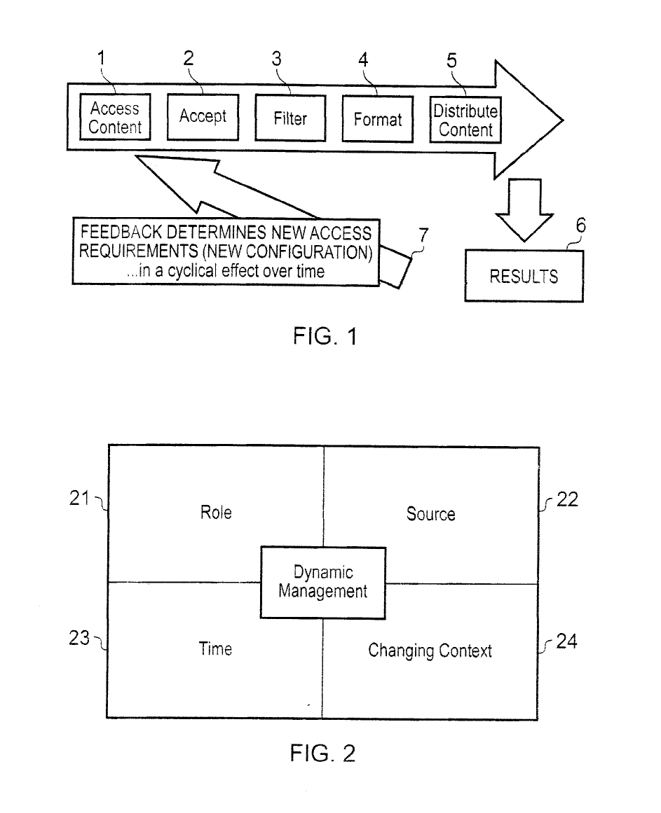

FIG. 1 provides a block picture of an automated process for retrieval of information;

FIG. 2 illustrates four key strategic variables in information retrieval;

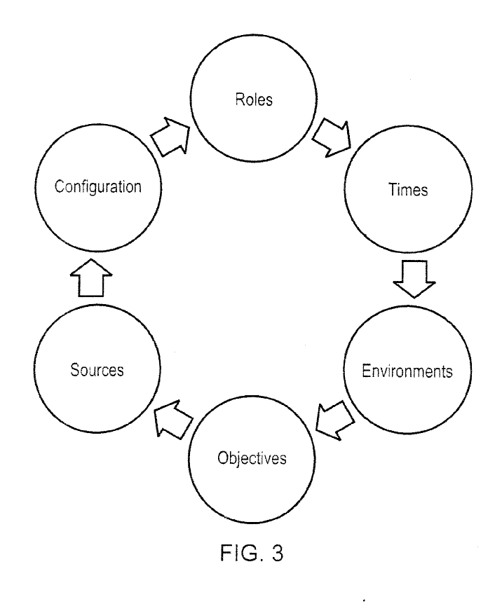

FIG. 3 provides a block illustration of operational variables with regard to information retrieval;

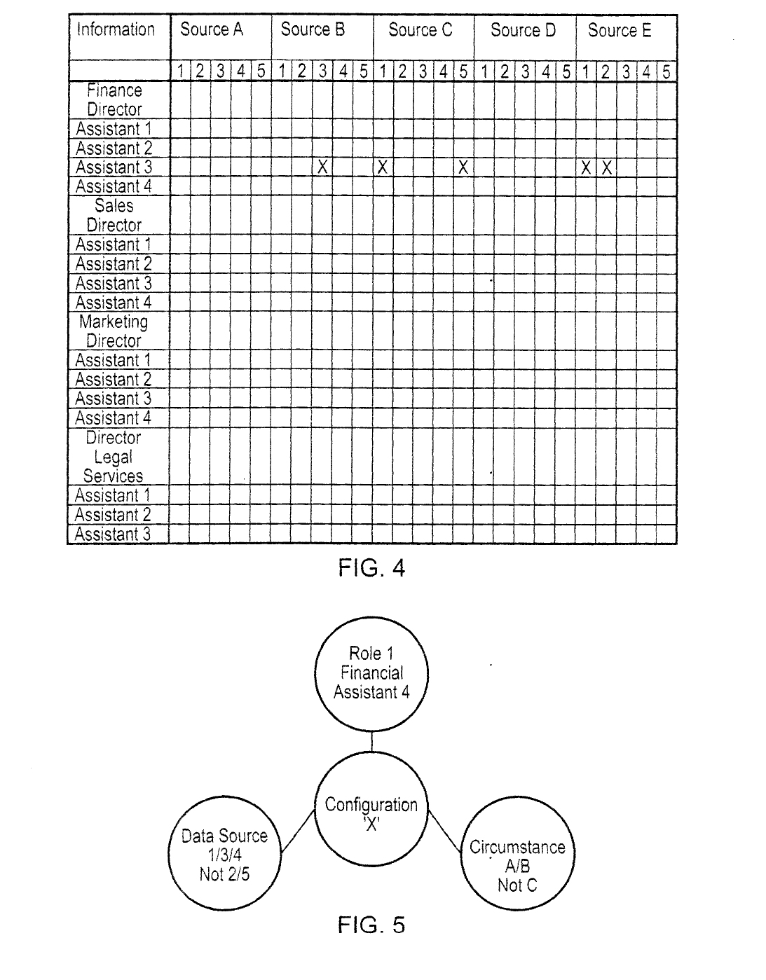

FIG. 4 is a table representing typical requirements and management with regard to information retrieval;

FIG. 5 provides an illustration with regard to configuration of a matrix for preferential use and necessary access profiles in accordance with aspects of the present invention;

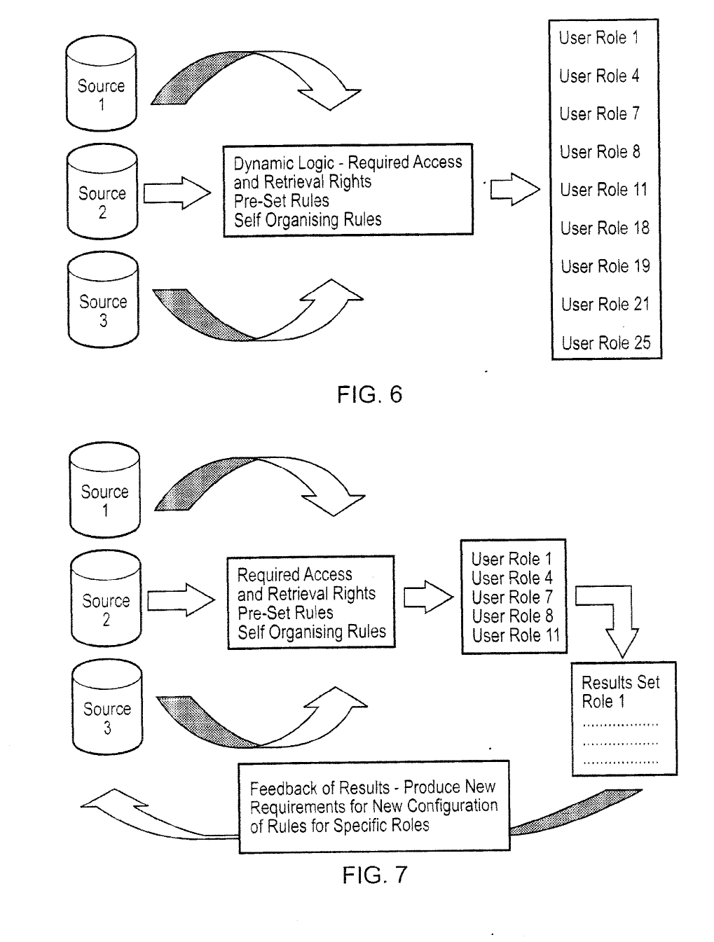

FIG. 6 is a graphic illustration of usage feedback in terms of adaptation of a stored access profile;

FIG. 7 provides a graphic illustration of cyclic adaptation of stored access profiles;

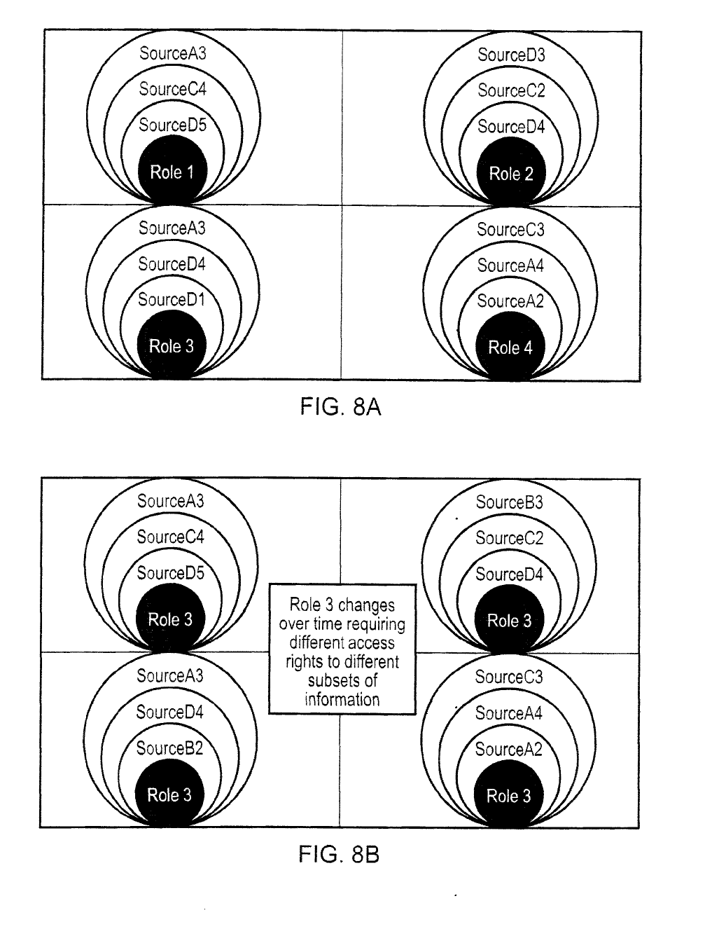

FIG. 8 illustrates a further adaptation of an access profile in accordance with aspects of the present invention;

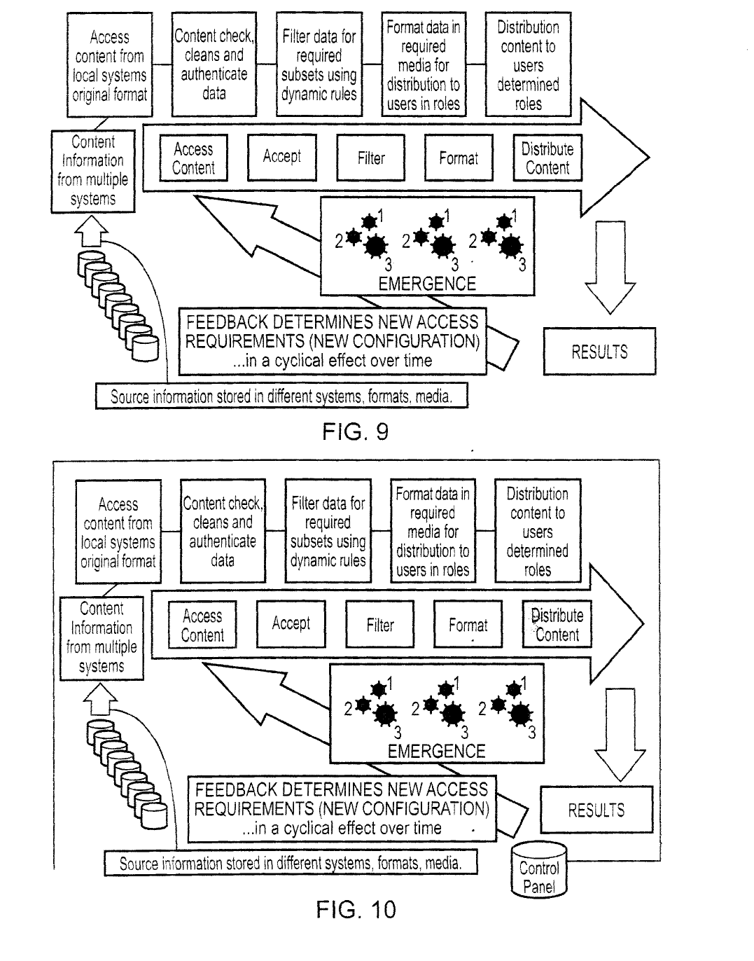

FIG. 9 is a schematic block diagram illustrating information retrieval in accordance with aspects of the present invention; and,

FIG. 10 provides a schematic illustration in block diagram form of an adaptation of the information retrieval method as defined in FIG. 9 with the addition of a controller.

Aspects of the present invention optimism the management, exploitation and use of diverse information sources within organizations. The approach enables organizations to use a method that automates the processing of information sets so that bespoke sub-sets of information can be viewed and used by specific roles, that is to say users within the organization. Furthermore, management of this complexity and change over time becomes available. Typically, these organizations need to exploit a range of different sources of information stored in different formats across a range of diverse functional roles. This facilitates efficient, effective access to relevant information enabling speedy decision making and potentially the exercise of efficiency and profitable choice. This approach helps to fulfill the needs of specific roles but within an overall process of monitoring the collective benefit to the organization as a whole.

This typically serves organizations that use a number of mediums and formats (typically software applications and reporting systems) but who require to automatically serve and monitor the information needs of a large number of roles each with different and sometimes overlapping functions. Each will typically have different requirements of information sources and not require access to others whether for efficiency, security, audit or similar purposes. This enables the organization to intelligently filter information and make it relevant to each individual user or the role being performed or the project to which a role or user has been assigned but within an overall awareness of the benefit to the organization as a whole as well as individual roles. The purpose is therefore twofold: Firstly, manage access to information sources to facilitate effective, efficient working practices for particular roles and secondly, to manage each roles access and use of information to facilitate the effective use of information for the ‘whole’ organization in an automated way.

In summary, the method intelligently supports and dynamically enables:

Automated management of storage environments for information sources useful to organizations needs

Automated alignment of storage operations to business requirements

Automates the role of storage/retrieval to meet Service Levels and business requirements directly

Integrates automatic storage/retrieval into Service Management

Storage/retrieval to automatically manage security, costs, productivity and efficiency

Automatic support and manage governance requirements for managing storage and access

Automatic data security and storage improved

Provides automatic integrated managed security to ensure data security

Automation to optimism security

Integrated dynamic storage/retrieval solution to support managed security

Organizations (both public and private and in various guises) are now able to use many forms of information and communications technology to access, collect, store and exploit large volumes of information. This can release a wealth of powerful data upon which the organization can approach management of decision making, task allocation and processing. However, the diversity of mediums and formats for the said storage and processing of information sets is diverse. These diverse mediums and formats present problems for users because they are invariably mutually exclusive and do not support interoperability.

Aspect of the present invention are designed to automatically and intelligently generate, filter, format and distribute information within a secure framework controlling both content and visibility by detecting relevant information sub-sets, as stored access profiles for particular roles. Results of processing such profiles or sub-sets of information are fed back into the system and new sub-sets of data can be identified and exploited by relevant roles or users.

FIG. 1 illustrates an automated process of identifying and accessing content information 1, accepting that content 2, filtering content 3, formatting content 4 and distributing results 5. Results 6 are then fed back 7 to the access control 1 mechanism and new adapted or modified profiles or sub-sets of data are identified.

Typically in the above circumstances information originates from multiple sources via multiple collection strategies, is collected in different formats and stored using different storage mechanisms. This creates a range of problems for organizations seeking to rely upon accurate, relevant and timely information for routine and critical decision making.

Examples of the problems encountered are:

The same Information is often duplicated and often in different formats;

Information sometimes in different formats is often stored using different platforms and mechanisms;

Information cannot be viewed in consistent and repeatable ways;

Due to the complex array of information sets stored in different mediums and formats often using different platforms, often results in the return of diverse and different results and arrays of information but on the basis of the same interrogatory query. The same question can produce different results and the same results can be produced by different questions because variables are not automatically controlled;

Obtaining a unified view of the information is not possible at either a holistic or atomistic level;

Cannot maintain a dynamic view of necessary data retrieved as the requirements for views change over time and circumstance—relevance is a shifting phenomenon;

Amalgamating information into useful sets in consistently relevant ways to a particular user's role is often not possible;

Decision making on the basis of information returns is often inherently unreliable;

Automation and information processing creates information mountains with protracted processing problems due to the exponential number of complex combinations of any two or more items of information 2n−(n+1) potential combinations of two or more variables;

Users of the information spend inexorable amounts of time trying to locate, access and use information relevant to their role at a given moment in time with huge opportunity costs incurred;

The same users cannot repeat the same interrogatory query to obtain corresponding results;

Multiple Licenses for multiple data source mediums and formats in systems for multiple users creates excessive cost;

In order to continually meet the information needs of the organization and its users delivery, filtering and distribution mechanisms are often stretched to the limit constantly meeting demands and requests for information, both internally within the organization and externally from customers and suppliers and are often unable to meet this demand with corresponding damage to the organization in reputation costs and missed opportunities;

The management of the ‘whole’ organizational process is difficult to undertake and correspondingly the identification and management of sub-sets of information is difficult. The following Case Studies provide examples where the invention will provide a new technical, novel and valuable approach to intelligently generate, filter, format and distribute information within a secure framework controlling both content and visibility by dynamically detecting relevant information sub-sets or access profiles for particular users and roles:

1. Mergers and acquisitions of companies where additional data sets from one or more companies need to be amalgamated with data sets from one or more other companies. Changing priorities, workflows and objectives present new environments that information bases need to fulfill. Over time new workflows and new objectives are learnt by the users and the organization as a whole that will result in new needs for information bases. Managing the amalgamation and information flow requirements is complex, time consuming and costly. Often, requirements are never satisfied with many ‘work-around’ situations or compromises sustaining over very long time periods.

2. Organizations operating in environments that are constantly subjected to change (over time) or where information fed back from a system(s) results in new configurations and depths of information and views produces workflow environments that need to change their information workflow arrangements to meet the new demands and needs.

3. Organizations that need to manage security over time, over different geographical locations and security levels along with a need to access different configurations and depths of information given the security protocols applicable at any one moment in time.

4. Organizations that have to adopt to compliancy standards for internal or external regulatory reasons or auditing typically require to monitor a range of different information access and monitoring requirements. This process is automated to alleviate the time consuming manual processing required with the inevitable inaccuracies it will bring.

FIG. 2 illustrates four key strategic variables of user Role/Source Information/Time/Changing Circumstance that require dynamic management to facilitate effective distribution of sub-sets of information that the present invention facilitates. The role of the User 21, the Sources of Information 22, the elements of Time 23 involved and the Changing Conditions (Context) 24 some of which may be detected by access to the information sources once filtered using aspects of the invention result in the cyclical process described herewith.

FIG. 3 illustrates a sub-set of variables impacting directly upon the processing of information sets by organizations as described in this disclosure. These variables often create massive complexity especially when the information sets involved or roles and objectives are large in number. However, it should be appreciated that even moderate numbers of variables in the way set out in FIG. 2 can produce highly complex and large numbers of potential combinations of variables. These large numbers often create confusion and require significant management time and effort along with processing power. Furthermore, most of this time and effort is wasted because most of the combinations detected are not relevant. The problem encountered is with deciding which combinations are relevant and which combinations are not. Users may not know until they investigate these and the numbers for consideration are often huge. Advantageously, there is optimization and automation of the detection of combinations. The net result is that the task described is never completed. The problem is often aggravated because once a configuration is set and understood circumstances change and another configuration is required. When the numbers of potential configuration is high this can prove an impossible task to manage effectively.

FIG. 3 illustrates the cyclical iteration of the processing of variables. The process is a continuous function over time and recognizes the importance of identifying and reacting to changing environmental and operating conditions. The creation of access pathways to information sources for roles in the organization is therefore an ongoing cycle of automated review and re-configuration determined by prevailing conditions. Automation provides labor and time saving opportunities.

FIG. 4 illustrates how aspects of the invention recognize and manages the complexity and diversity created by the large number of potential combination of variables operating in information flow processes. The left axis indicates a range of roles performed by users and user Assistants and the top axis a range of different Information Data Sources. This Matrix manages just one stage of the operation at point ‘x’ in time. It can be seen that a User Finance Directors' Assistant Number 3 has been given access to a Visible Amalgamation/Array of the combined information from data Source B (3), data Source C (1), data Source E (1) and data Source E (2). This is an access profile stored for that user typically in the controller, Finance Director's Assistant Number 3. This user has not been given access to any other information data sources. The information presented has also been formatted for viewing in one simple and understandable format relevant to the relevant Users role. This facilitates the applicable of Data Distribution/Process/Management requirements recognized during processing in accordance with the method as it ebbs and flows over time with changing circumstances.

It should be noted from FIG. 4 that the approach is user role and responsibility sensitive. It embodies an approach that leverages automated managed interoperability and managed communications requirements. That is, it recognizes and embodies the specific needs of a user performing a specific role but within a trust framework set for the organization as a whole:

1. Aspects of the invention manage the problem of dynamic complexity created by the complex array of user Roles, Data Sources and changing circumstances over time.

2. Complexity created by the addition of (A) New data sources (B) Changes in data models (C) New Roles (D) Changes in Workflow Requirements of Roles.

3. In the above environment in FIG. 4 there are 20 Roles and 5 major information sources. We have disregarded the sub-sets of 5 in each information source for the purposes of the following explanation. In this example with 25 variables there are over 33.5 Million potential combinations of two or more of these roles and data sources. When time, changing data sources, changing data models, new roles and changes in workflow requirements of roles are added plus the sub-sets in each information source are included as variables then the environment becomes extremely complex and requires sophisticated automated management techniques. This would be beyond human configuration simply based upon time, changing conditions and the potential numbers involved. The complexity created by many to many variables including time and shifting contextual role and functional requirements results in potential combinations of pertaining variables in the process (over time and changing circumstances) and also a problem.

In managing diverse variables as indicated above in FIG. 4 organizations are required to deal with the exponential geometric growth that occurs when the growth rate of a function is proportional to the function's current size. The growth rate follows an exponential rule that often results in massive numbers of potential combinations. The larger the quantity gets, then the faster the potential combination grows and the more likely the organization is to suffer confusion and consequential inertia driven by too much inconsistent information.

In FIG. 4 it will be seen that a range of information sources exist that provide important information assets to the organization. Each of these sources of information is stored in a different way using different mediums and formats. There are also a range of different Users in the form of organizational roles. Each User can view the various sources of information but this presents major obstacles to the organization as a whole. For example:

Processing, accessing, amalgamating, sorting and sifting information on a piece-meal basis is time consuming and labor intensive if done by hand and without automation;

This is laborious, complex and time consuming in terms of accessing and joining together two or more sub-sets;

This requires a broad range of information processing (ICT) skills often not relevant to the task in-hand;

There are massive combinatorial associations to consider in terms of information sets and sub-sets and without time consuming experiments the most appropriate sub-sets cannot be identified—automation in accordance with aspects of the present invention assists this process;

‘Best Practice’ and optimized processing are undermined due to the large number of choices involved;

Management and control of the access, processing and use of information is almost impossible using a piece-meal approach because there are too many variable situations and circumstances to control. Furthermore, over time requirements change and additional levels of diversity of operation are introduced adding to the complex nature of the task.

In FIG. 4 it will be seen that various roles and sub-roles of users (Assistants to Roles) can be assigned access profiles to different information data sources and data sub-sources of information in-line with their requirements and usefulness to the organization as a whole. As new information data sources become available due to mergers and acquisitions, new processes or changing environmental conditions require wider, short or simply a different sub-set then this access and control mechanism can be changed to meet the demands. This can also be undertaken automatically by the iterative recognition of emergent trends and patterns. Time and changing circumstances play an important part in the requirement for the invention. Circumstances change over time and so requirements also change over time. What was once a relevant operation on day one may not be a relevant operation to perform on day seven. The management of access to relevant information sources across the range of roles by users is thus managed.

FIG. 5 illustrates how the configuration of a Matrix produces relevant and simple sub-sets of information from a massive multiplicity of potential configurations. It will be appreciated that this configuration can be changed automatically as a direct result of feed-back from results of the processing of the information sub-set as depicted in FIGS. 4, 7, 9 and 10. This iteration over time produces a process which evolves to meet User and organizational needs.

FIG. 6 and FIG. 7 illustrate how the process or method is managed. The figures illustrate that initially the method is configured to meet determined requirements for information access by specific roles. FIG. 7 illustrates how feed-back from the results of the method determines how the method as a whole will then change and re-configure to meet changing and emerging requirements. For example, it will be appreciated that a User given certain access rights to amalgamated information sub-sets will determine results that may give rise to new requirements. An example may be the identification of a new business opportunity, a newly identified growth area or some other facet of knowledge that indicates a new set of amalgamated sources of information should be accessed to monitor or/and exploit this new knowledge. The Stock Market would be an example of the need to harness a new trend identified.

FIG. 7 illustrates the feedback process in operation. Here the results of access to information sources of a particular type has resulted in the identification of a new and relevant operational requirement for a new sub-set of information. This is fed back to the information source where a new configuration is created and distributed.

FIG. 7 illustrates the cyclical effect of how at the beginning of the process a set of deterministic rules is pre-defined. FIG. 7 also illustrates how the feedback of results from FIGS. 4 and 5 are fed back into the process to help generate new rules and new requirements for information sources to be distributed to Users in roles or their requirements.

FIG. 8a illustrates a set of four separate and distinct user roles (1, 2, 3, 4) that require different sub-sets of data at point ‘X’ in time (FIG. 4). In reality this may apply to a great many roles across a wide and diverse network of roles within the organization and this complex management and role is facilitated by aspects of the invention.

FIG. 8b illustrates how one role (Role 3) has changed over time and how access to different configuration of sub-sets of information required has changed as conditions changed. This is facilitated by the automated feed-back of results as new inputs into the process as illustrated in FIG. 7.

Aspects of the present invention enable the organization to intelligently maintain control of the customization of operating environment to enhance efficiency, dynamically maintain relevance of operations to requirements and to manage this over changing time and circumstances. For example:

Dynamic management Information or Output from Multiple Systems becomes routine;

Information sources and sub-sets are dynamically personalized to roles. Sorting and Sifting Data from different sources into sub-sets (Role Specific) (Project Specific) (Function Specific) for different purposes;

Dynamic control established on access—known as ‘Push’;

Dynamic searching constrained within that role or combination of roles—known as ‘Pull’;

Dynamic management of the organization as a whole can be truly agnostic as to sources mediums and formats thereby allowing them to concentrate on the information and not what format it is stored within;

Dynamic management of Interface of Holistic and Atomistic Requirements—(Highly Complex Activity)

Aspects of the invention recognizes intelligently the dynamic evolution by iteration of outcomes and results which is used to effect information being Pushed;

Managing access to information for different roles is done automatically at strategic level and so the user does not need to manage at a personal level access;

Common syntax for access reporting regardless of source;

Common syntax approach for ease of common interpretation regardless of source.

The Figures shown illustrate how aspects of the invention enable the organization to manage access to information sources depending upon the role, requirements and circumstances at any given time. It has been explained that the potential number of these configurations is very large and therefore typically introduces confusion within organizations about which role requires access to which information source and for which purpose. Additionally, how this should be managed and monitored over time and changing circumstances.

An important facet of aspects of the invention is that the user requires no knowledge or training in the methodology and administratively this is reduced to an absolute minimum. This allows the user to concentrate on the task in-hand and employ the skills for the function and role being undertaken rather than a different skill set involving information and communications technology configuration. A controller manages at the center on behalf of each and every role or user.

The organizational center can intelligently enable access to specific information, documents or reports that are available for use along with any rules governing their visibility to users, groups and roles. It will be appreciated that these were originally stored in different media, formats and systems.

An aspect of the solution is the ability to manage all information sources, all applications and all users (Roles) from a single and central point of control and allow this to perform this function by reference to changing requirements over time.

This maximizes an organizations investment in existing technologies by extending the reach of them in unified and sub-set ways to many roles, functions and projects. This reduces licenses required in extending the use of each technology and therefore reducing the annual maintenance costs for each technology. This will also help avoid the capital spend on new licenses and avoid the annual maintenance, upgrade and training costs.

Intelligent dynamic management and control of access and use of diverse information sources enables better security of information avoiding damage by sending the wrong information or allowing access to someone else's information.

Intelligent dynamic auditing of information concerning which user roles it is sent to and how user roles are using it will help manage governance and regulatory compliance.

Central intelligent dynamic management of access and control in the way designed helps to determine which reports and which technologies are not being made use of. Potential reductions in associated costs and opportunity costs can be countenanced.

The invention does not require aggregated expense of distributed client operational software.

The invention is concerned with aggregation of data and not analysis or deciphering. Aspects of the present invention are concerned with the intelligent management of logistical requirements of access and security. The user in a specific role is enabled to undertake such task by access to highly relevant accurate information sources and sub-sets of sources. This is termed ‘Perspective Management’ in aspects of the invention.

The net effect of aspects of the invention is that it enables the organization to intelligently generate, filter, format and distribute information in a security framework controlling both content and document visibility over time and to meet and monitor changing conditions.

FIG. 9 illustrates the method in accordance with aspects of the invention. Information stored in different systems and formats is accepted and stored in original format for cleansing, authenticating and content checks. The information is then filtered for required amalgamated sub-sets by dynamic rules configured to meet set and emerging standards many of which will not be known about until they are identified. The information is distributed to users in their roles. The information can be viewed by users in the pre-designated amalgamated sets and these results are fed back into the process for use in the dynamic reconfiguration of new emergent rules that generate new sub-sets. The process iterates in a cyclical fashion controlled at the center by a control mechanism that can be manually and automatically manipulated and configured to generate rules and sub-sets of amalgamated information.

FIG. 10 illustrates how the method in accordance with aspects of the present invention as a whole can be managed by a Controller to:

Automate, and Configure Access to Content

Automate, and Configure Filtering in Sets and Sub-Sets

Automate, Format Information in different ways, styles and media and formats

Automate, Distribute Information to Users in defined manners

Automate, Create and Delete user Roles based on pre-defined scenarios or emergent properties

Automate, Configure and Create Rules Matrix to create Rules and Recognize New Emerging Scenarios and Content

Automate, Configure and Create Matrix to Action Rules for New Emerging Scenarios and Content

Automate, Configure, Control and Launch operation of New Rules

Automate, Configure and Create Audit Trails and Monitoring Mechanisms for Content Control and measurement

Aspects of the invention will connect to each data source of information in order to access and retrieve the data content in its original format. Aspects of the invention will then proceed to filter the data content and authenticate the resultant data for the required sub-sets using a series of dynamic rules which interpret the relationships between each sub-set and user. The rules for each sub-set and role will determine how each sub-set is formatted and distributed for each role. The rules for the dynamic distribution will then determine how each sub-set is to be distributed to each role. The rules matrix governing the relations between the sub-sets, roles and distributions will enable the process to be automated and yet remain dynamic in managing changes over time to the source information, the sub-sets (access profiles) and the roles. Changes to the rules and relationships between sub-sets, roles and distributions and access to the results will be managed and effected through a central controller which stores relevant access profiles. The method and the rules used for producing each sub-set of results and which Role it was distributed and which user accessed the role to read the results will be captured for audit, compliance and information monitoring purposes. Users granted permission via the central control panel to access the results for a role will also be permitted to retrieve or ‘Pull’ sub-sets of information or search for information within sub-sets of information relating to the role using the same rules.

The invention is comprised of and uses an automated storage facility with the ability to automatically recognize and connect to a range of different information sources and their respective storage facilities regardless of the media or format of each. Each and every source of information is automatically accessed and information is automatically ‘pulled’ from the relevant source into the storage facility. The information is automatically stored in its original format for automated monitoring and where necessary manual reference. The information is then subjected to an automatic filtering process and an automated systematic authentication procedure to ascertain what information is present and what is not present. Automated cross referencing of each and every source of information is undertaken to ascertain automatically where gaps appear in information sources and how these can be filled using information from other sources. The results of that process are automatically used to suggest ranges of potential new rules for authentication and use within the process described as a whole. Where ‘obvious’ gaps or opportunities are detected by the automated process the system is automatically configured to report these to the central control panel for authentication and launch if authorized. This can be automated for automatic launch and acceptance which then produces new results as a seamless process. The process of gap identification via the cross referencing process is launched and ‘merging’ of information sources is undertaken to fill gaps identified. Once a gap is filled a record of this is stored so that the same procedure or access profile can be used again if another gap bearing the same or similar characteristics is found. A filtering process is then applied to each and every source of information to divide them into relevant classes relevant to roles performed. Relationships between these filtered sources of information are recognized against a set of rules each of which can be configured automatically singularly and/or in conjunction with each other depending upon the required outcomes for each role. A Matrix is used to manage, track and adjust the process over time. The Matrix governing the relations between the sub-sets, Roles and distributions is automated allowing dynamic changes over time to be written into the procedure and the generation of new Rules to serve the requirements of Roles that change over time. What is relevant to perform and monitor at time ‘X’ may not be relevant to perform and monitor at time ‘Y’. However, what was relevant to perform and monitor at time ‘X’ may need to be replaced by a new requirement and procedure to be performed and monitored at time ‘Y’. Changes to the rules and relationships between sub-sets, roles and distributions and access to the results is monitored, managed and manipulated by the central control panel automatically or manually. The process and the rules which can be considered an access profile can be used for producing each sub-set of results and which Role it was distributed to and which user accessed the Role to read the results is subject of recording and audited by a set of automated filters. This provides a continuous compliance and information monitoring process including statistical and rule based measures of how often or not access was used to particular outcomes. Various and dynamic measures of deviation are used to measure, monitor and control results and provide new suggestions for new rules. These are used to measure efficiency and effectiveness and are reported to the central control panel for consideration by users. Activity measures in this procedure provide assistance to advanced decision support procedures about the maintenance of the Rules Matrix, new changes required and editing required to existing rules. Outcomes of the process are automatically distributed to Users where they are treated as ‘new’ information subsets. These are automatically monitored using adjustable conventions to measure (a) whether the results meet standards required (b) whether adjustments are required to deliver the required results or newly recognized (not previously known results but now known due to the new results) requirements discovered that need to be monitored and returned as results. Users can be granted permission via the central control panel to access the results manually and can also be permitted to retrieve or ‘Pull’ dynamic sub-sets of information or search for information within sub-sets of information relating to the Role using the same rules and new Rules determined by the procedure as a whole.

In view of the above it will be appreciated that aspects of the present invention utilize a method and process in order to retrieve information in the form of data from a number of data sources. In accordance with aspects of the present invention each one of these data sources may be a potential repository for necessary data for a user. Users will have different roles and functions within an organization in order to achieve certain tasks such as report writing or monitoring production processes etc. In such circumstances information or pieces of information from one particular data source may be all that is required or data of a particular type. Thus, providing a global multi combination system in which the user must individually combine and select necessary combination to achieve a necessary result will become time consuming. Furthermore, as indicated some data sources will be inaccessible by a particular user at a certain level of authority and each data source will typically operate in accordance with different rational.

In accordance with aspects of the present invention as indicated relational rules are defined as a stored access profile defining a combination of specific data sources and/or data types for a particular process or action. These processes or actions will be user specific or role specific. In such circumstances a stored access profile will be allocated to a user at least initially in order to collect and collate the necessary information for use by that user. In such circumstances the user will retrieve a data collection as a formed or collected combination of necessary data in accordance with the stored access profile. As indicated this access profile will list and define specific data sources and/or data types necessary for the user to perform their role or function. Of particular advantage with respect to aspects of the present invention is that the user manually or more advantageously through a controller will monitor the proportionate usage of the necessary data to adapt the stored access profile. In such circumstances the stored access profile in terms of the combination of defining specific data sources and/or data types are attributable to a user in terms of their role and allocated task will be adjusted. In such circumstances if particular data sources or data types are not utilized by the user then the proportionate usage will be utilized with regard to adjusting the access profile. Data sources and data types which are used will significantly add to the proportionate usage of the necessary data and therefore maintain the stored access profile. In such circumstances by feedback control the stored access profile will become more focused upon those data sources and data types which are proportionately more used by the user in their role or allocated task. By concentrating upon the data sources and data types used mostly by a user in their role or task it will be appreciated that the necessary combinations and therefore connection and switching processes to obtain that necessary data will be reduced progressively with experience. Thus, with a more focused stored access profile the user will be able to obtain the information from the necessary disbursed data sources in terms of their communications network and place less demand upon that network.

It will also be understood that in terms of licensing fees for utilization of software and data within an organization such fees will be minimized. The user will only use a particular piece of software or data source if necessary in accordance with their role or task.

In terms of initial operation as indicated generally a user will have a role or task definition which can be specified by a stored access profile. This stored access profile will define data collection in the form necessary to perform that task by the user. In accordance with aspects of the present invention dependent upon the particular user a stored access profile will be adapted and modified proportionately based upon the necessary data retrieved and used by the user to optimism speed and operation of the method in accordance with aspects of the present invention. The user can manually adapt the access profile or more typically monitor through the controller the access profile utilized. This controller will review proportionate usage of the necessary data by the user and then adapt the stored access profile accordingly to reduce the number of combinations for that user.

In accordance with aspects of the present invention further storage can be provided as a temporary store for the necessary data retrieved periodically by the user. This temporary store will therefore act as a buffer including necessary retrieved data from the data sources or of data types to allow a periodic function or task to be performed by the user. Upon the next retrieval of the necessary data the stored access profile will be adapted to retrieve proportionately the necessary data based upon the user's prior usage and therefore optimism the system and method in accordance with aspects of the present invention.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-12. (canceled)

13. A method of information retrieval from a plurality of data sources, each data source being a potential repository of necessary data, determining a stored access profile defined by a combination of specific data sources and/or data types on a particular data source, allocating a stored data access profile to a user, the user retrieving a data collection to form the necessary data in accordance with the stored access profile with the data collection taken from the specific data sources and/or data types, the user and/or a controller monitoring proportional usage of the necessary data to dynamically adapt the stored access profile in terms of the combination defined by the specific data sources and/or data types on a particular data source for subsequent retrieval of the necessary data by the user, the adaption dependent upon dynamically maintaining at least a predefined quotient for the usage of the necessary data and/or parts of the necessary data.

14. A method as claimed in claim 13 wherein the method includes combining stored data access profiles as allocated to the user.

15. A method as claimed in claim 13 wherein the controller is arranged to store a plurality of standard data access profiles.

16. A method as claimed in claim 15 wherein the controller is arranged to allocate one of the standard data access profiles to the user.

17. A method as claimed in claim 16 wherein the controller dependent upon the proportional usage is arranged to dynamically adapt the standard access profile allocated to a user dependent upon the proportionate usage by that user.

18. A method as claimed in claim 13 wherein the method includes automated amalgamation of the stored data access profile with other data access profiles dependent upon the proportional usage.

19. A method as claimed in claim 13 wherein the method periodically refreshes and/or replaces and/or resets the stored data access profile to a default stored data access profile.

20. A method as claimed in claim 13 wherein the method includes the user defining a task and the method determining the closest stored access profile suitable for the task.

21. A method as claimed in claim 13 wherein the data collection is a sub-set of data information packages defined by the stored access profile.

22. A method as claimed in claim 13 wherein there are a plurality of users and/or controllers.

23. A system operated in accordance with the method of information retrieval from a plurality of data sources, each data source being a potential repository of necessary data, determining a stored access profile defined by a combination of specific data sources and/or data types on a particular data source, allocating a stored data access profile to a user, the user retrieving a data collection to form the necessary data in accordance with the stored access profile with the data collection taken from the specific data sources and/or data types, the user and/or a controller monitoring proportional usage of the necessary data to dynamically adapt the stored access profile in terms of the combination defined by the specific data sources and/or data types on a particular data source for subsequent retrieval of the necessary data by the user, the adaption dependent upon dynamically maintaining at least a predefined quotient for the usage of the necessary data and/or parts of the necessary data.

24. A computer network including a plurality of data sources operated in accordance with the method of information retrieval from a plurality of data sources, each data source being a potential repository of necessary data, determining a stored access profile defined by a combination of specific data sources and/or data types on a particular data source, allocating a stored data access profile to a user, the user retrieving a data collection to form the necessary data in accordance with the stored access profile with the data collection taken from the specific data sources and/or data types, the user and/or a controller monitoring proportional usage of the necessary data to dynamically adapt the stored access profile in terms of the combination defined by the specific data sources and/or data types on a particular data source for subsequent retrieval of the necessary data by the user, the adaption dependent upon dynamically maintaining at least a predefined quotient for the usage of the necessary data and/or parts of the necessary data.
